(19) United States
(12) Patent Application Publication
(10) Pub. No.: US 2022/0231533 A1
(43) Pub. Date: Jul. 21, 2022

(54) IN-VEHICLE BACKUP POWER SUPPLY DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Koki Uchida, Yokkaichi-shi, Mie (JP)

(21) Appl. No.: 17/612,309

(22) PCT Filed: May 11, 2020
(86) PCT No.: PCT/JP2020/018761

§ 371 Date: Nov. 18, 2021

(30) Foreign Application Priority Data
May 27, 2019 (JP) 2019-098238

(51) Int. Cl. H02J 9/06; H02J 7/00; H01M 10/615; H01M 10/625; B60R 16/033

(52) U.S. Cl. CPC H02J 9/06; H02J 7/0013; H02J 7/0063; H01M 10/615; B60L 50/60; B60R 16/033; H02J 2207/20; H01M 2220/20; H01M 10/625

(57) ABSTRACT

Provided is a technique that can raise the temperature of a battery unit more effectively with a simpler configuration. An in-vehicle backup power supply device includes a battery unit in which a plurality of unit batteries are connected in series, a voltage conversion unit provided with a plurality of converters that step up or down a voltage that is input and output the resultant voltage, and a control unit configured to control the voltage conversion unit, a first circuit unit constituting a power path between the voltage conversion unit and the battery unit; and a second circuit unit constituting a power path between the voltage conversion unit and a load, the battery unit is provided with a plurality of conversion target portions, the conversion target portions are constituted by the unit battery or a plurality of the unit batteries connected in series.

### CROSS-REFERENCE TO RELATED APPLICATIONS

This application is the U.S. national stage of PCT/JP2020/018761 filed on May 11, 2020, which claims priority of Japanese Patent Application No. JP 2019-098238 filed on May 27, 2019, the contents of which are incorporated herein.

### TECHNICAL FIELD

The present disclosure relates to an in-vehicle backup power supply device.

### BACKGROUND ART

Conventionally, battery modules formed by a plurality of unit batteries connected in series are used as drive power supplies for electric cars and the like. JP 2014-54143A discloses an example of a power supply device provided with this kind of battery module.

In this kind of battery module, the charging capacity of unit batteries depends on the temperature, and the lower the temperature of the unit batteries, the more the internal resistance of the unit batteries increases and the charging capacity decreases. In other words, the lower the temperature of the unit batteries is, the narrower the chargeable regions of the unit batteries are. Due to this characteristic, in an environment in which the temperature of the unit batteries is likely to decrease (e.g., in a cold area or in winter), the substantial charging capacity of the unit batteries is likely to decrease.

In view of this problem, in the power supply device of JP 2014-54143A, the temperature of a charging module (battery unit) is raised by performing constant voltage charging and constant current charging, using the power supplied from an external charger to mitigate the problem incurred by a low temperature state. However, the power supply device of the JP 2014-54143A is configured such that an external charger is necessarily required in order to raise the temperature of an assembled battery.

In view of this, the present disclosure provides a technique with which it is possible to raise the temperature of a battery unit more effectively with a simpler configuration.

### SUMMARY

An in-vehicle backup power supply device according to the present disclosure is an in-vehicle backup power supply device comprising: a battery unit; a control unit, a first circuit unit, and a second circuit unit. The battery unit includes a plurality of unit batteries connected in series. The voltage conversion unit is provided with a plurality of converters that step up or down a voltage that is input and output the resultant voltage. The control unit is configured to control the voltage conversion unit. The first circuit unit constitutes a power path between the voltage conversion unit and the battery unit. The second circuit unit constitutes a power path between the voltage conversion unit and a load, wherein the battery unit is provided with a plurality of conversion target portions. The conversion target portions are constituted by one of the unit batteries or a plurality of the unit batteries connected in series. The first circuit unit is provided with a plurality of first conductive paths that are conductive paths that connect the highest potential electrodes of the conversion target portions and the respective converters to each other. A plurality of second conductive paths are conductive paths that connect the lowest potential electrodes of the conversion target portions and the respective converters to each other. The second circuit unit is provided with a plurality of third conductive paths that are conductive paths arranged between the converters and a conductive path on the load side. When a first condition is satisfied, the control unit causes the plurality of converters to perform a discharging operation for stepping up or down a potential difference between the first conductive path and the second conductive path as an input voltage and applying an output voltage to the third conductive path. When a second condition is satisfied, the control unit causes one or more of the converters to perform the discharging operation, and the other converter or converters to perform a charging operation for stepping up or down a voltage that is applied to the third conductive path and applying the output voltage between the first conductive path and the second conductive path.

### Advantageous Effects of Invention

According to the present disclosure, it is possible to raise the temperature of a battery unit more effectively with a simpler configuration.

### BRIEF DESCRIPTION OF DRAWINGS

FIG. 1 is a circuit diagram schematically showing an in-vehicle backup power supply device according to a first embodiment.

FIG. 2 is a flowchart showing an operation of the in-vehicle backup power supply device according to the first embodiment.

FIG. 3 is a circuit diagram schematically showing an in-vehicle backup power supply device according to a second embodiment.

FIG. 4 is a flowchart showing an operation of the in-vehicle backup power supply device according to the second embodiment.

FIG. 5 is a circuit diagram schematically showing an in-vehicle backup power supply device according to a third embodiment.

### DETAILED DESCRIPTION OF PREFERRED EMBODIMENTS

First, embodiments of the present disclosure will be listed and described.

An in-vehicle backup power supply device according to the present disclosure includes a battery unit in which a plurality of unit batteries are connected in series, a voltage conversion unit provided with a plurality of converters that step up or down a voltage that is input and output the resultant voltage, and a control unit configured to control the voltage conversion unit. The in-vehicle backup power supply device includes a first circuit unit constituting a power path between the voltage conversion unit and the battery unit, and a second circuit unit constituting a power path between the voltage conversion unit and a load. The battery unit is provided with a plurality of conversion target portions. A conversion target portion is constituted by the unit battery or a plurality of the unit batteries connected in series. The first circuit unit is provided with a plurality of first conductive paths and a plurality of second conductive paths. The plurality of first conductive paths are conductive paths that connect the highest potential electrodes of the conversion target portions and the respective converters. The plurality of second conductive paths are conductive paths that connect the lowest potential electrodes of the respective conversion target portions and the respective converters. The second circuit unit 31 is provided with a plurality of third conductive paths that are conductive paths arranged between the converters and the conductive paths on the load side. When the first condition is satisfied, the control unit causes the plurality of converters to perform a discharging operation for stepping up or down a potential difference between the first conductive path and the second conductive path as an input voltage and applying an output voltage to the third conductive path. Also, when the second condition is satisfied, the control unit causes one converter to perform the discharging operation. In addition to this, the control unit causes the other converter to perform a charging operation for stepping up or down a voltage that is applied to the third conductive path as an input voltage and applying the output voltage between the first conductive path and the second conductive path. With this configuration, with this in-vehicle backup power supply device, it is possible to raise the temperature of the battery unit by causing one converter to perform the discharging operation from the battery unit, and the other converter to perform the charging operation to the battery unit. In other words, with this in-vehicle backup power supply device, it is possible to raise the temperature of a battery unit more effectively with a simpler configuration without providing a dedicated configuration for raising the temperature of the battery unit.

In an in-vehicle backup power supply device according to the present disclosure, when the second condition is satisfied, the control unit may cause at least two or more of the plurality of converters to perform an operation for alternately repeating the charging operation and the discharging operation.

With this configuration, since the converters do not perform only one of the charging operation and the discharging operation, it is possible to avoid a case in which the unit batteries are overcharged or overdischarged, and the converters can continuously perform both the charging operation and the discharging operation. In this manner, this in-vehicle backup power supply device can favorably raise the temperature of the battery unit.

In an in-vehicle backup power supply device according to the present disclosure, in the battery unit, at least one of the plurality of the unit batteries and the plurality of the conversion target portions are arranged side by side along a predetermined direction. The control unit may perform a suppression control for setting an output power in the discharging operation of the converter that corresponds to the unit batteries or the conversion target portions located at the central portion in the predetermined direction to be smaller than an output power at the time of discharging operation of the converters that corresponds to the unit batteries or the conversion target portions located at the two ends in the predetermined direction.

With this configuration, it is possible to suppress an excessive increase in temperature of the central portion of the battery unit, and a case in which a difference in temperature occurs between the two sides and the central portion of the battery unit.

In an in-vehicle backup power supply device according to the present disclosure, the control unit may perform the suppression control at least in a case in which a temperature at the central portion is higher than a temperature to the outer side of the central portion.

With this configuration, it is possible to perform the suppression control only in the case in which a difference in temperature occurs between the outside and the central portion of the battery unit.

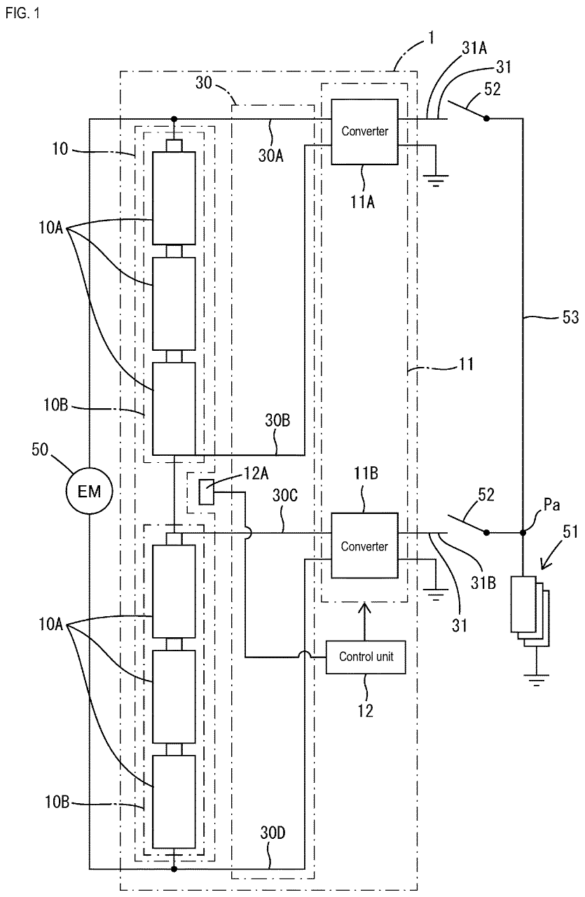

As shown in FIG. 1, an in-vehicle backup power supply device 1 of a first embodiment (hereinafter also referred to as “power supply device 1”) includes a battery unit 10, a voltage conversion unit 11, and a control unit 12. Batteries such as lithium-ion batteries formed by a plurality of unit batteries 10A (cells) are used in the battery unit 10. The battery unit 10 is used as a power supply for outputting power for driving electromotive devices (e.g., motor) in vehicles such as hybrid cars or electric cars (EV (electric vehicles)). The battery unit 10 has a configuration in which a plurality of unit batteries 10A configured as lithium ion batteries are connected in series form a module that constitutes one conversion target portion 10B, and a plurality of the conversion target portions 10B are connected in series such that they can output a desired output voltage.

In the battery unit 10, for example, a plurality of unit batteries 10A and a plurality of conversion target portions 10B are arranged side by side along a predetermined direction (up-down direction in FIG. 1). A power generation device 50 mounted in a vehicle is electrically connected to the electrodes at the two ends of the battery unit 10, and the battery unit 10 can be charged by the power generation device 50. The power generation device 50 is configured as a known in-vehicle power generator, and can generate power through rotation of a rotational axis of an engine (not shown). When the power generation device 50 operates, power generated by the power generation device 50 is rectified, and then supplied to the battery unit 10 as DC power.

The battery unit 10 is provided with a temperature detection unit 12A. The temperature detection unit 12A is formed by a known temperature sensor, for example, and arranged in contact with a surface portion or the like of the battery unit 10 or near the surface portion of the battery unit 10 without being in contact therewith. The temperature detection unit 12A can output a voltage value indicating the temperature at the position at which it is arranged (i.e., the temperature of the surface or the temperature near the surface of the battery unit 10) and input the voltage value to the control unit 12.

The voltage conversion unit 11 includes a plurality of converters 11A and 11B. The converters 11A and 11B are, for example, configured as known bi-directional step up/down DC-DC converters provided with semiconductor switching elements, inductors, and the like, and step up or down the voltage that is input into them and output the resultant voltage. The converters 11A and 11B are electrically connected to the conversion target portions 10B via a first circuit unit 30. The first circuit unit 30 forms the power path between the voltage conversion unit 11 and the battery unit. The first circuit unit 30 is provided with first conductive paths 30A and 30C, and second conductive paths 30B and 30D. The converter 11A is electrically connected to the highest potential electrode in the conversion target portion 10B via the first conductive path 30A. The converter 11A is electrically connected to the lowest potential electrode in the conversion target portion 10B via the second conductive path 30B. The potential difference between the first conductive path 30A and the second conductive path 30B is input to the converter 11A as an input voltage. The converter 11B is electrically connected to the highest potential electrode in the conversion target portion 10B via the first conductive path 30C. The converter 11B is electrically connected to the lowest potential electrode in the conversion target portion 10B via the second conductive path 30D. The potential difference between the first conductive path 30C and the second conductive path 30D is input to the converter 11B as an input voltage.

The converters 11A and 11B are electrically connected to switch elements 52 for switching electrical connection/non-electrical connection between the converters 11A and 11B and the load-side conductive path 53 that supplies power to the load 51, via third conductive paths 31A and 31B included in a second circuit unit 31. The third conductive path 31A is arranged between the converter 11A and the load-side conductive path 53 on the load 51 side, and the third conductive path 31B is arranged between the converter 11B and the load-side conductive path 53 on the load 51 side. The second circuit unit 31 forms a power path between the voltage conversion units 11 and the load 51. The switch elements 52 are formed by MOSFETs (Metal Oxide Semiconductor Field Effect Transistors) or the like, for example. The switch elements 52 are electrically connected to the load 51 via the load-side conductive path 53.

When a first condition is satisfied, the converters 11A and 11B can be controlled by the control unit 12 and perform a discharging operation for stepping up or down the potential difference between the first conductive paths 30A and 30C and the second conductive paths 30B and 30D as the input voltage and applying the output voltage to the third conductive paths 31A and 31B. That the first condition is satisfied may mean that, for example, an ignition switch (not shown) provided in the vehicle is switched from off to on.

When a second condition is satisfied, controlled by the control unit 12, one converter 11A or 11B can perform the discharging operation, and in addition to this, the other converter 11A or 11B can perform a charging operation (hereinafter also referred to as “temperature raising operation”) for stepping up/down the voltage applied to the third conductive paths 31A or 31B as the input voltage and applying the output voltage between the first conductive paths 30A and 30C, or the second conductive paths 30B and 30D. Specifically, when the one converter 11A or 11B performs the discharging operation, the other converter 11A or 11B performs a charging operation based on the output voltage that is output to the third conductive paths 31A and 31B, and generates a predetermined potential difference between the first conductive paths 30A and 30C and the second conductive paths 30B and 30D and outputs the potential difference as the output voltage. That the second condition is satisfied may mean, for example, that the voltage value indicating the temperature of the battery unit 10 that is output from the temperature detection unit 12A (hereinafter also referred to as “voltage value from the temperature detection unit 12A”) has reached a predetermined threshold or less (i.e., indicating a predetermined temperature or less).

The control unit 12 is constituted mainly by a microcomputer, for example, and includes a computation device such as a CPU (Central Processing Unit), a memory such as a ROM (Read Only Memory) or a RAM (Random Access Memory), an A/D converter and the like. The control unit 12 can grasp the temperature of the battery unit 10 based on a signal from the temperature detection unit 12A that detects the temperature of the surface or in the vicinity of the surface of the battery unit 10.

The control unit 12 controls the operation of the voltage conversion unit 11 based on the voltage value from the temperature detection unit 12A. Specifically, when the first condition is satisfied, the control unit 12 performs a control for causing the voltage conversion unit 11 to perform the discharging operation. When the second condition is satisfied, the control unit 12 performs a control for causing the voltage conversion unit 11 to perform the temperature raising operation.

Next, the operation of the power supply device 1 will be described.

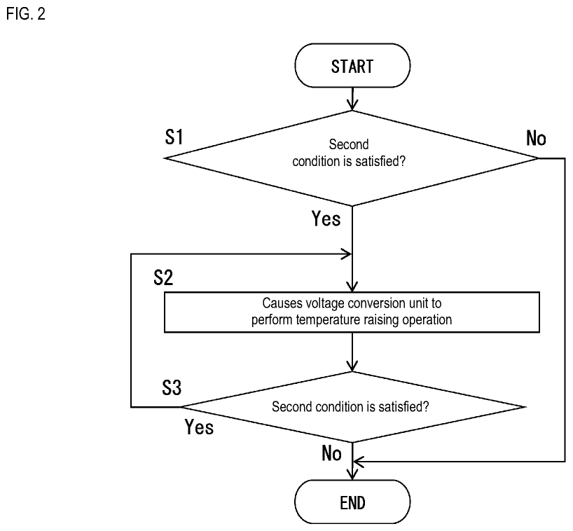

First, the user of the vehicle in which the power supply device 1 is mounted starts a preliminary operation of the vehicle by using a remote controller or the like that can instruct the vehicle to perform a predetermined operation, for example. The preliminary operation is, for example, an operation performed when the ignition switch is off and about to be turned on. The preliminary operation ends when a predetermined condition is satisfied. That the predetermined condition is satisfied may mean, for example, that the voltage value from the temperature detection unit 12A is greater than the threshold value. In the preliminary operation, as shown in FIG. 2, the control unit 12 determines the temperature of the battery unit 10. First, the control unit 12 determines whether the second condition has been satisfied (step S1). Specifically, the control unit 12 determines whether the voltage value from the temperature detection unit 12A is the threshold value or less. The threshold value is stored in the ROM of the control unit 12 or the like, for example. Also, if it is determined that the voltage value from the temperature detection unit 12A is greater than the threshold value (step S1: No), the control unit 12 ends the processing and repeats the control shown in the flowchart of FIG. 2.

If it is determined that the voltage value from the temperature detection unit 12A is the threshold value or less (step S1: Yes) (i.e., if the second condition is satisfied), the control unit 12 advances to step S2 and causes the voltage conversion unit 11 to perform the temperature raising operation. In this manner, the temperature of the conversion target portion 10B, to which one converter 11A or 11B that performs the discharging operation is connected, is raised by the conversion target portion 10B discharging. Also, the temperature of the conversion target portion 10B, to which the other converter 11A or 11B that performs the charging operation is connected, is raised by the conversion target portion 10B being charged. At this time, the third conductive paths 31A and 31B are electrically connected to the load-side conductive path 53 via the switch elements 52. In this manner, the third conductive paths 31A and 31B of the converters 11A and 11B are electrically connected to each other, and power can be exchanged between the converters 11A and 11B. Also, a switch (not shown) is provided between a point Pa on the load-side conductive path 53 and the load 51 such that power is not supplied to the load 51 due to this switch being opened in the temperature raising operation.

Next, the control unit 12 advances to step S3 and determines whether the second condition has been satisfied. Specifically, the control unit 12 determines whether the voltage value from the temperature detection unit 12A is the threshold value or less. If it is determined that the voltage value from the temperature detection unit 12A is a threshold or less (step S3: Yes), the control unit 12 advances to step S2. Also, if it is determined that the voltage value from the temperature detection unit 12A is greater than the threshold value (step S3: No), the control unit 12 ends the processing and temperature raising operation, and repeats the control shown in the flowchart of FIG. 2.

When the control unit 12 causes the voltage conversion unit 11 to perform the temperature raising operation, the control unit 12 causes at least two or more of the plurality of converters 11A and 11B to perform an operation for alternately repeating the charging operation and discharging operation. In the first embodiment, when the voltage conversion unit 11 performs the temperature raising operation, the two converters 11A and 11B complementarily and alternately repeat the charging operation and the discharging operation. Specifically, when the converter 11A performs the discharging operation, the converter 11B performs the charging operation, and when the converter 11B performs the discharging operation, the converter 11A performs the charging operation. These operations are alternately repeated.

More specifically, first, the switch elements 52 are closed, and the third conductive paths 31A and 31B are electrically connected to each other via the load-side conductive path 53. At this time, the switch (not shown) between the point Pa on the load-side conductive path 53 and the load 51 is opened such that power is not supplied to the load 51. Then, in the first period, the converter 11A performs the discharging operation for stepping up or down the potential difference between the first conductive path 30A and the second conductive path 30B as the input voltage and applying the output voltage to the third conductive path 31A. Then, based on the output voltage of the third conductive path 31B, the converter 11B generates a predetermined potential difference between the first conductive path 30C and the second conductive path 30D and output the potential difference as the output voltage to charge the conversion target portion 10B.

Then, in the second period, the converter 11B performs the discharging operation for stepping up or down the potential difference between the first conductive path 30C and the second conductive path 30D as the input voltage and applying the output voltage to the third conductive path 31B. Then, based on the output voltage of the third conductive path 31A, the converter 11A generates a predetermined potential difference between the first conductive path 30A and the second conductive path 30B and outputs the potential difference as the output voltage to charge the conversion target portion 10B. Note that, the first period and the second period are set so as to not overlap with each other.

Due to the control unit 12 causing the converters 11A and 11B to alternately repeat the charging operation and the discharging operation, the temperature raising operation can be continued without the battery unit 10 being overcharged or overdischarged. By repeatedly executing the flowchart shown in FIG. 2, the control unit 12 periodically compares the voltage value indicating the temperature of the battery unit 10 and the threshold value. If it is determined that the voltage value indicating the temperature of the battery unit 10 is greater than the threshold value (i.e., the second condition is not satisfied), the control unit 12 ends the temperature raising operation performed by the voltage conversion unit 11. At this time, since a predetermined condition is satisfied, the preliminary operation ends.

After the preliminary operation ends, the ignition switch is turned on. Accordingly, the first condition is satisfied. Then, the converters 11A and 11B are controlled by the control unit 12 to perform the discharging operation for stepping up or down the potential difference between the first conductive paths 30A and 30C and the second conductive paths 30B and 30D as the input voltage and applying the output voltage to the third conductive paths 31A and 31B. Also, when the first condition is satisfied in the discharging operation, the switch (not shown) is closed, and power is supplied from the load-side conductive path 53 to the load 51.

Next, the effect of this configuration will be illustrated.

An in-vehicle backup power supply device 1 according to the present disclosure includes; a battery unit 10 in which a plurality of unit batteries 10A are connected in series, a voltage conversion unit 11 provided with a plurality of converters 11A and 11B that step up or down a voltage that is input and output the resultant voltage, and a control unit 12 configured to control the voltage conversion unit 11. The in-vehicle backup power supply device 1 further includes a first circuit unit 30 constituting a power path between the voltage conversion unit 11 and the battery unit 10, and a second circuit unit 31 constituting a power path between the voltage conversion unit 11 and a load 51. The battery unit 10 is provided with a plurality of conversion target portions 10B. A conversion target portion 10B is constituted by the unit battery 10A or a plurality of the unit batteries 10A connected in series. The first circuit unit 30 is provided with a plurality of first conductive paths 30A and 30C and a plurality of second conductive paths 30B and 30D. The plurality of first conductive paths 30A and 30C are conductive paths that connect the highest potential electrodes of the conversion target portions 10B and the respective converters 11A and 11B. The plurality of second conductive paths 30B and 30D are conductive paths that connect the lowest potential electrodes of the respective conversion target portions 10B and the respective converters 11A. The second circuit unit 31 is provided with a plurality of third conductive paths 31A and 31B that are conductive paths arranged between the converters 11A and the conductive paths on the load 51 side. When the first condition is satisfied, the control unit 12 causes the plurality of converters 11A and 11B to perform a discharging operation for stepping up or down a potential difference between the first conductive path 30A and 30C and the second conductive path 30B and 30D as an input voltage and applying an output voltage to the third conductive path 31A and 31B. Also, when the second condition is satisfied, the control unit 12 causes one converter 11A or 11B to perform the discharging operation. In addition to this, the control unit 12 causes the other converter 11A or 11B to perform a charging operation for stepping up or down a voltage that is applied to the third conductive path 31A and 31B as an input voltage and applying the output voltage between the first conductive path 30A and 30C and the second conductive path 30B and 30D.

In this manner, the in-vehicle backup power supply device 1 causes the one converter 11A or 11B to perform the discharging operation from the battery unit 10. In addition to this, the in-vehicle backup power supply device 1 can raise the temperature of battery unit 10 by causing the other converter 11A or 11B to perform the charging operation on the battery unit 10. In other words, with the in-vehicle backup power supply device 1, it is possible to raise the temperature of a battery unit 10 more effectively with a simpler configuration without providing a dedicated configuration for raising the temperature of the battery unit 10.

When the second condition is satisfied, the control unit 12 of the in-vehicle backup power supply device 1 according to the present disclosure causes the plurality of converters 11A and 11B to alternately repeat the charging operation and the discharging operation.

With this configuration, a situation in which the converters 11A and 11B perform only one of the charging operation or the discharging operation can be prevented. For this reason, it is possible to avoid a case in which the unit batteries 10A are overcharged or overdischarged, and the converters 11A and 11B can continuously perform both the charging operation and discharging operation. Accordingly, the in-vehicle backup power supply device 1 can favorably raise the temperature of the battery unit 10.

### Second Embodiment

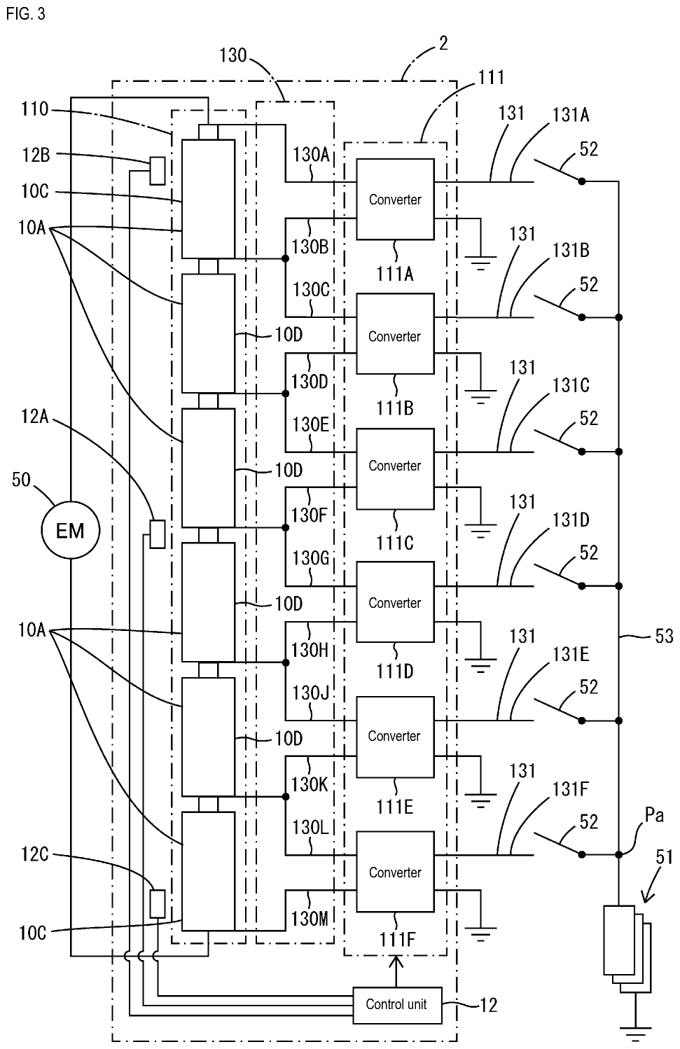

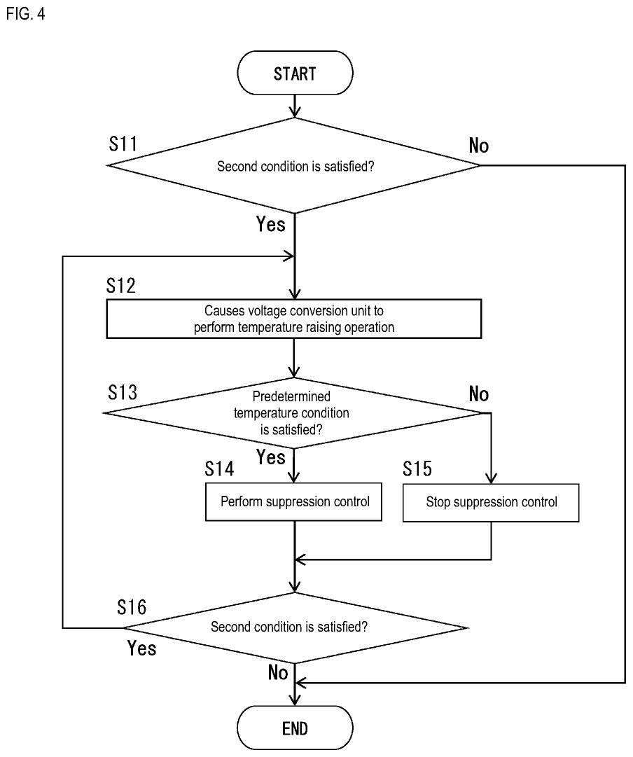

Next, an in-vehicle backup power supply device 2 (hereinafter referred to as “power supply device 2”) according to a second embodiment will be described with reference to FIGS. 3 and 4. The power supply device 2 is different from that of the first embodiment in that the converters 111A, 111B, 111C, 111D, 111E, and 111F (hereinafter also referred to as “converters 111A to 111F”) are provided in correspondence with the respective unit batteries 10A. The same constituent elements are given the same reference numerals and the description of their structure, operation, and effect will be omitted.

The battery unit 110 of the power supply device 2 according to the second embodiment is formed by the plurality of unit batteries 10A connected in series. In the battery unit 110, the plurality of unit batteries 10A are arranged side by side along a predetermined direction.

The battery unit 110 is provided with a plurality of temperature detection units 12A, 12B, and 12C. Specifically, the temperature detection unit 12A is arranged in a predetermined direction in which the unit batteries 10A are arranged, in contact with the surface portion of a central portion 10D of the battery unit 110 or in the vicinity of the surface portion of a central portion 10D without contact. The temperature detection unit 12B is arranged in contact with the surface portion of one end 10C or in the vicinity of the surface portion of the one end 10C without contact. The temperature detection unit 12C is arranged in contact with the surface portion of the other end 10C or in the vicinity of the surface portion of the other end 10C without contact.

The voltage conversion unit 111 includes the converters 111A to 111F. The converters 111A to 111F are provided in correspondence with the respective unit batteries 10A. The converters 111A to 111F are electrically connected to the respective unit batteries 10A via the first circuit unit 130. The first circuit unit 130 is provided with first conductive paths 130A, 130C, 130E, 130G, 130J, and 130L (hereinafter also referred to as “first conductive paths 130A to 130L”) and second conductive paths 130B, 130D, 130F, 130H, 130K, and 130M (hereinafter also referred to as “second conductive paths 130B to 130M”). The first conductive paths 130A to 130L respectively and electrically connects the high potential electrode of the unit batteries 10A to the converters 111A to 111F that correspond to the unit batteries 10A. The second conductive path 130B to 130M electrically connect the low potential electrodes of the unit batteries 10A and the converters 111A to 111F that correspond to the respective unit batteries 10A.

An electrode between two unit batteries 10A connected in series is electrically connected to the second conductive path that is connected to the converter that corresponds to the high potential unit battery 10A, and to the first conductive path that is connected to the converter that corresponds to the low potential unit battery 10A. The second conductive path 130B connected to the converter 111A that corresponds to the high potential unit battery 10A and the first conductive path 130C connected to the converter 111B that corresponds to the low potential unit battery 10A are electrically connected to the electrode between the unit batteries 10A for example. The potential difference between the first conductive path and the second conductive path is input to the converters as the input voltage. The potential difference between the first conductive path 130A and the second conductive path 130B is input to the converter 111A as the input voltage, for example.

The converters 111A to 111F are electrically connected to the switch elements 52 for switching conduction/non-conduction to the load 51 via the third conductive paths 131A, 131B, 131C, 131D, 131E, and 131F (hereinafter also referred to as “third conductive paths 131A to 131F”) included in the second circuit unit 131.

Next, the operation of the power supply device 2 will be described.

First, the user of the vehicle in which the power supply device 2 is mounted starts a preliminary operation of the vehicle by using a remote controller or the like that can instruct the vehicle to operate, for example. As shown in FIG. 4, in the preliminary operation, the control unit 12 determines the temperature of the battery unit 110. First, the control unit 12 determines whether the second condition is satisfied (step S11). Specifically, the control unit 12 determines whether the voltage values indicating the temperatures of the battery unit 110 that are input from the temperature detection units 12A, 12B, and 12C (hereinafter also referred to as “voltage values from the temperature detection units 12A, 12B, and 12C”) are a threshold value or less.

If it is determined that at least one of the voltage values from temperature detection units 12A, 12B, or 12C is the threshold value or less (step S11: Yes) (i.e., if the second condition is satisfied), the control unit 12 advances to step S12 and causes the voltage conversion unit 111 to perform the temperature raising operation. At this time, the third conductive paths 131A to 131F are electrically connected to the load-side conductive path 53 via the switch elements 52. In this manner, the third conductive paths 131A to 131F of the converters 111A to 111F are electrically connected to each other, and power can be exchanged between the converters 111A to 111F. Also, a switch (not shown) is provided between the load-side conductive path 53 and the load 51 such that power is not supplied from the load-side conductive path 53 to the load 51 in the temperature raising operation.

When the control unit 12 causes the voltage conversion unit 111 to perform the temperature raising operation, the control unit 12 causes the plurality of converters 111A to 111F to perform an operation for alternately repeating the charging operation and discharging operation.

For example, first, the switch elements 52 are closed, and the third conductive paths 131A to 131F are electrically connected to each other via the load-side conductive path 53. Then, the switch (not shown) between the load-side conductive path 53 and the load 51 is opened such that power is not supplied to the load 51. Then, in the first period, the converters 111A, 111B and 111C perform the discharging operation for stepping up or down the potential difference between the first conductive paths 130A, 130C, and 130E and the second conductive paths 130B, 130D, and 130F as the input voltage and applying the output voltage to the third conductive paths 131A, 131B, and 131C. In addition to this, based on the output voltage of the third conductive paths 131D, 131E, and 131F, the converters 111D, 111E, and 111F generate a predetermined potential difference between the first conductive paths 131G, 131J, and 131L and the second conductive paths 130H, 130K, and 130M and output the potential difference as the output voltage. In this manner, the unit batteries 10A that correspond to the converters 111D, 111E, and 111F are charged.

In the second period, the converters 111D, 111E, and 111F perform the discharging operation for stepping up or down the potential difference between the first conductive paths 130G, 130J, and 130L and the second conductive paths 130H, 130K, and 130M as the input voltage and applies the output voltage to the third conductive paths 131D, 131E, and 131F. In addition to this, based on this output voltage of the third conductive paths 131A, 131B, and 131C, the converters 111A, 111B, and 111C generate a predetermined potential difference between the first conductive paths 130A, 130C, and 130E and the second conductive paths 130B, 130D, and 130F and output the potential difference as the output voltage. In this manner, the unit batteries 10A that correspond to the converters 111A, 111B, and 111C are charged. Note that, the first period and the second period are set so as to not overlap with each other.

Here, the operation in which the charging operation and the discharging operation of the converter 111A, 111B, and 111C and the converter 111D, 111E, and 111F are alternately repeated is performed, but the combination of the converters that alternately repeats the charging operation and the discharging operation is not limited to this. For example, a configuration is also possible in which the converters 111A, and 111B, 111C, 111D, 111E, and 111F are combined with each other, or the converter 111A, and 11B, and 111C, 111D, 111E, and 111F are combined with each other, and the like.

Next, the control unit 12 advances to step S13 and determines whether a predetermined temperature condition has been satisfied. Specifically, the control unit 12 may compare a voltage value at a central portion with voltage values at the two end portions. The voltage value at the central portion is a voltage value from the temperature detection unit 12A arranged in the central portion 10D of the battery unit 110 in a predetermined direction in which the unit batteries 10A are arranged when the control unit 12 causes the voltage conversion unit 111 to perform the temperature raising operation. The voltage values at the two end portions are voltage values from the temperature detection units 12B and 12C arranged at the two ends 10C of the battery unit 110.

When performing the temperature raising operation, since, in the predetermined direction in which the unit batteries 10A are arranged, the contact area of the central portion 10D with ambient air is smaller than that of the two ends 10C of the battery unit 110, the temperature of the central portion 10D is more likely to increase. When the control unit 12 causes the voltage conversion unit 111 to perform the temperature raising operation, for example, the control unit 12 compares the voltage value at the central portion with the voltage values at the two end portions and checks the difference between the central voltage value and the voltage values at the two end portions. If the predetermined temperature condition according to which the voltage value at the central portion is greater than the voltage values at the two end portions and the difference between these values are greater than a predetermined threshold is satisfied (step S13; Yes), the control unit 12 advances to step S14 to perform a suppression control. The suppression control is a control for setting the output power to the third conductive path 131B, 131C, 131D, and 131E in the discharging operation performed by the converters 111B, 111C, 111D, and 111E that correspond to the unit batteries 10A in the central portion 10D, smaller than the output power in the discharging operation performed by the converters 111A and 111F that correspond to the unit batteries 10A at the two ends 10C.

If the voltage value at the central portion is not greater than the voltage values at the two end portions, or the difference between the voltage value at the central portion and the voltage values at the two end portions is a predetermined threshold or less (step S13: No) (i.e., a predetermined temperature condition is no longer satisfied), the control unit 12 stops the suppression control (step S15).

Also, if the predetermined temperature condition is satisfied, then the control unit 12 may perform the suppression control as below in accordance with the difference between the voltage value at the central portion and the voltage values at the two end portions. For example, if the predetermined temperature condition is satisfied and the difference between the voltage value at the central portion and the voltage values at the two end portions increases, the control unit 12 may decrease the output power to be output to the third conductive paths 131B to 131E in the discharging operation performed by the converters 111B to 111E that correspond to the unit batteries 10A in the central portion 10D. Also, if a predetermined temperature condition is satisfied and the difference between the voltage value at the central portion and the voltage values at the two end portions decreases, the control unit 12 may increase the output power to be output to the third conductive paths 131B to 131E in the discharging operation performed by the converters 111B to 111E that correspond to the unit batteries 10A of the central portion 10D.

Next, the control unit 12 advances to step S16 and determines whether a second condition is satisfied. Specifically, if it is determined that all the voltage values from the temperature detection units 12A, 12B, and 12C are greater than the threshold value (step S16: No) (i.e., the second condition is not satisfied), the control unit 12 ends the temperature raising operation performed by the voltage conversion unit 111. At this time, the preliminary operation ends. Also, if it is determined at least one of the voltage values from the temperature detection units 12A, 12B, or 12C is the threshold value or less (step S16: Yes) (i.e., the second condition is satisfied), the control unit 12 advances to step S12.

After ending the preliminary operation, the control unit 12 turns on the ignition switch. Accordingly, the first condition is satisfied. The control unit 12 causes the converters 111A to 111F to perform the discharging operation for stepping up or down the potential difference between the first conductive paths 130A to 130L and the second conductive paths 130B to 130M as the input voltage and applying the output voltage to the third conductive paths 131A to 131F. Also, when the first condition is satisfied in the discharging operation, the switch (not shown) is closed, and thus power is supplied from the load-side conductive path 53 to the load 51.

Next, the effect of this configuration will be illustrated.

In the battery unit 110 of the in-vehicle backup power supply device 2 according to the present disclosure, the plurality of unit batteries 10A are arranged side by side along a predetermined direction. The control unit 12 sets the output voltage to be output to the third conductive paths 131B to 131E in the discharging operation performed by the converters 111B to 111E that correspond to the unit batteries 10A located at the central portion 10D in a predetermined direction of the battery unit 110, smaller than the output voltage to be output by the converters 111A and 111F that correspond to the unit batteries 10A located at the two ends 10C in a predetermined direction of the battery unit 110.

With this configuration, it is possible to avoid a case in which the temperature of the central portion 10D of the battery unit 110 excessively increases and suppress a case in which a difference in temperature occurs between the two ends 10C and the central portion 10D of the battery unit 110.

In the in-vehicle backup power supply device 2 according to the present disclosure, the control unit 12 performs the suppression control in the case where the temperature of the central portion 10D is higher than the temperature at the outside thereof.

With this configuration, it is possible to perform the suppression control only in the case in which there is a difference in temperature between the two ends 10C and the central portion 10D of the battery unit 110.

### Third Embodiment

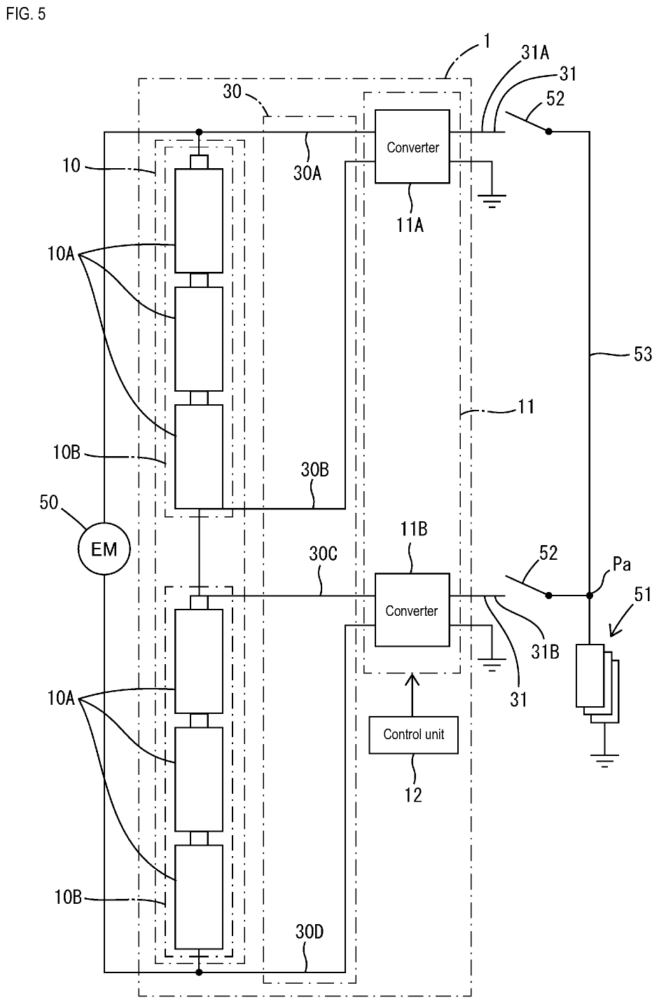

Next, an in-vehicle backup power supply device 3 (hereinafter also referred to as “power supply device 3”) according to a third embodiment will be described with reference to FIG. 5. The power supply device 3 is different from the first embodiment in that no temperature detection unit is provided. The same constituent elements as the first embodiment are given the same reference numerals, and the description of their structure, operation, and effect will be omitted.

First, the user of the vehicle in which the power supply device 3 is mounted starts a preliminary operation of the vehicle by using a remote controller or the like that can instruct the vehicle to perform a predetermined operation, for example. For example, in the preliminary operation, the control unit 12 causes the voltage conversion unit 11 to perform the temperature raising operation. Also, the temperature of the conversion target portion 10B to which one converter 11A or 11B that performs the discharging operation is connected is raised by the conversion target portion 10B discharging. Also, the temperature of the conversion target portion 10B to which the other converter 11A or 11B that performs the charging operation is connected is raised by the conversion target portion 10B being charged. At this time, the third conductive paths 31A and 31B are electrically connected to the load-side conductive path 53 via the switch elements 52. In this manner, the third conductive paths 31A and 31B of the converters 11A and 11B are electrically connected to each other, and power can be exchanged between the converters 11A and 11B. Also, a switch (not shown) is provided between the load-side conductive path 53 and the load 51 such that power is not supplied to the load 51 due to this switch being opened in the temperature raising operation.

Next, the control unit 12 determines whether a predetermined time has elapsed since the temperature raising operation started. If it is determined that a predetermined time has not elapsed since the temperature raising operation started, the control unit 12 continues the temperature raising operation. If it is determined that a predetermined time has elapsed since the temperature raising operation started, the control unit 12 ends the temperature raising operation. At this time, since a predetermined condition is satisfied, the preliminary operation ends.

The operation of the converters 11A and 11B of the voltage conversion unit 11 in the temperature raising operation in the third embodiment is similar to that of the first embodiment. In the power supply device 3, due to the control unit 12 causing the converters 11A and 11B to alternately repeat the charging operation and the discharging operation, the temperature raising operation can be continued without the battery unit 10 being overcharged or overdischarged.

After ending the preliminary operation, the control unit turns on the ignition switch. Accordingly, the first condition is satisfied. The control unit 12 causes the converters 11A and 11B to perform the discharging operation for stepping up or down the potential difference between the first conductive paths 30A and 30C and the second conductive paths 30B and 30D as the input voltage and applying the output voltage to the third conductive paths 31A and 31B. Also, when the first condition is satisfied in the discharging operation, the switch (not shown) is closed, and thus power is supplied from the load-side conductive path 53 to the load 51.

### Other Embodiments

The configuration is not limited to the embodiments described using the above description and the drawings, and for example, the following embodiments are also encompassed within the technical scope of the present invention.

Although in the second embodiment, a configuration of the converter 111A that corresponds to the unit battery 10A is illustrated, a configuration is also possible in which, in the battery unit in which a plurality of the conversion target portions formed by a plurality of unit batteries are arranged in series, the operation of the converters that correspond to the respective conversion target portions may be controlled as in the second embodiment.

In the second embodiment, based on the voltage value from a plurality of temperature detection units 12A, the output voltage from the converters 111B, 111C, 111D, and 111E in the central portion 10D to the third conductive paths 131B, 131C, 131D, and 131E is suppressed. On the other hand, a configuration is also possible in which the output voltage to the third conductive path from the converters located in the center of the central portion is set smaller than the output voltage to the third conductive path from the converters located at the outside of the central portion.

If there are three or more converters, in the temperature raising operation, a converter that does not perform any operation may also be present, in addition to the converter that performs the discharging operation and the converter that performs the charging operation.

The embodiments disclosed herein should be construed to be exemplary in all aspects, and not be restrictive. The present invention is not limited to the embodiments disclosed herein, but defined in the claims, and intended to include all modifications within the meaning and the scope equivalent thereof.

1. An in-vehicle backup power supply device comprising:
a battery unit in which a plurality of unit batteries are connected in series;
a voltage conversion unit provided with a plurality of converters that step up or down a voltage that is input and output the resultant voltage;
a control unit configured to control the voltage conversion unit;
a first circuit unit constituting a power path between the voltage conversion unit and the battery unit; and
a second circuit unit constituting a power path between the voltage conversion unit and a load,
wherein the battery unit is provided with a plurality of conversion target portions,
the conversion target portions are constituted by one of the unit batteries or a plurality of the unit batteries connected in series,
the first circuit unit is provided with a plurality of first conductive paths that are conductive paths that connect the highest potential electrodes of the conversion target portions and the respective converters to each other, and a plurality of second conductive paths that are conductive paths that connect the lowest potential electrodes of the conversion target portions and the respective converters to each other,
the second circuit unit is provided with a plurality of third conductive paths that are conductive paths arranged between the converters and a conductive path on the load side,
when a first condition is satisfied, the control unit causes the plurality of converters to perform a discharging operation for stepping up or down a potential difference between the first conductive path and the second conductive path as an input voltage and applying an output voltage to the third conductive path, and
when a second condition is satisfied, the control unit causes one or more of the converters to perform the discharging operation, and the other converter or converters to perform a charging operation for stepping up or down a voltage that is applied to the third conductive path and applying the output voltage between the first conductive path and the second conductive path.

2. The in-vehicle back up power supply device according to claim 1, wherein, when the second condition is satisfied, the control unit causes at least two or more of the plurality of converters to perform an operation for alternately repeating the charging operation and the discharging operation.

3. The in-vehicle back up power supply device according to claim 1, wherein, in the battery unit, at least one of the plurality of the unit batteries and the plurality of the conversion target portions are arranged side by side along a predetermined direction, and the control unit performs a suppression control for setting an output power in the discharging operation of the converter that corresponds to the unit batteries or the conversion target portions located at the central portion in the predetermined direction to be smaller than an output power at the time of discharging operation of the converters that corresponds to the unit batteries or the conversion target portions located at the two ends in the predetermined direction.

4. The in-vehicle back up power supply device according to claim 3, wherein, the control unit performs the suppression control at least in a case in which a temperature at the central portion is higher than a temperature to the outer side of the central portion.

5. The in-vehicle back up power supply device according to claim 2, wherein, in the battery unit, at least one of the plurality of the unit batteries and the plurality of the conversion target portions are arranged side by side along a predetermined direction, and the control unit performs a suppression control for setting an output power in the discharging operation of the converter that corresponds to the unit batteries or the conversion target portions located at the central portion in the predetermined direction to be smaller than an output power at the time of discharging operation of the converters that corresponds to the unit batteries or the conversion target portions located at the two ends in the predetermined direction.
